(19) United States
(12) Patent Application Publication
(10) Pub. No.: US 2014/0136964 A1
(43) Pub. Date: May 15, 2014

(54) Color Synchronizer

(71) Applicant: PORTRAIT DISPLAYS, INC., Pleasanton, CA (US)

(72) Inventor: J. Michael James, San Francisco, CA (US)

(73) Assignee: PORTRAIT DISPLAYS, INC., Pleasanton, CA (US)

(21) Appl. No.: 13/676,075

(22) Filed: Nov. 13, 2012

(51) Int. Cl. G09G 5/02

(52) U.S. Cl. CPC G09G 5/02
USPC 715/255

(57) ABSTRACT

A system and method for synchronizing color on at least two devices. A Color Synchronizer color standard is established for applying to display devices, where the color standard causes the actual colors of items in images to be displayed on the display device. The color standard is loaded onto a client computing device for applying to a display. The color standard is used to calibrate the display device. Images in a Web page are prepared based on the color standard for sending to the client computer display. Images of the items are captured by a camera calibrated to the color standard. An identifying code, such as a QR code, is embedded into the Web page. An identifier read from the QR code is used to verify that the Web page is certified. If certified, apply the color standard to the calibrated client display to adjust the colors on the display.

### FIELD OF THE INVENTION

The present invention relates generally to monitors and displays, and more particularly but not exclusively to color space management and digital display control.

### BACKGROUND OF THE INVENTION

Colors of an item, as represented on a computer display, should be the actual colors of the item being represented. The human eye is very sensitive to small changes in color. People can perceive when two colors are different. There are no easy to use tools to correct for incorrect color between what is seen on a computer screen and the actual object being represented.

Color is a very complicated function. It is composed of three primaries: red, green and blue. Each of these primaries has two independent variables in saturation and brightness. And, all these variables interact.

Human perception of color is composed of three separate sensors in the eye: for red, green and blue light. Each of these elements can sense many different levels of intensity. Colors are made up of combinations of the three different elements at different intensities. The human eye can see over 16 million different colors.

A number of color characteristics determines how colors appear on a display. Color characteristics include red, blue and green color, which are the chromaticity or gamut of the display, white point, which is the color value of the maximum white level, and gamma, which is the non-linear relationship between the increase in a value of the red, green, or blue signal and the increase in the red, green, or blue brightness or luminance.

If any of these color values are represented differently by the source and client display, then the visually-perceived colors will be different. The result of a difference in color characteristics will be that the item being viewed by the user on the client display will be different from the colors of the actual object being represented on the Web site. It would be desirable to have a system that will avoid the problems with this approach.

### BRIEF SUMMARY

In preferred embodiments of the invention, methods and systems are provided for synchronizing color on at least two devices. For example, in the case of a client computing device and a source device, the same color standard that is used by the source device to prepare a web page can also be provided to the client computing device to allow the client device to be reset to display the intended colors.

In accordance with one aspect of these preferred embodiments, a QR code is provided for inclusion in a certified web page that has been prepared using a calibrated display loaded with the color standard values. The QR code reflects an identifier correlated with the certified web page that can be detected by the client computing device.

The identifier can be used by the client computing device to look up the color standard that was used by the source device. A table of identifiers known to be correlated to certified pages can be used for this purpose. If a match is found, the corresponding color standard is loaded into the client computing or otherwise applied to the associated display. If the display was not previously using the appropriate standard, the color of the display will be changed based on the appropriate color standard.

This brief summary is provided to introduce a selection of concepts in a simplified form that are further described in the detailed description. It is not intended to be exhaustive or to limit the inventions to the precise forms disclosed.

### BRIEF DESCRIPTION OF THE DRAWINGS

Preferred embodiments of the present invention are illustrated by way of example, and not by way of limitation, in the figures of the accompanying drawings and in which like reference numerals refer to similar elements and in which:

FIG. 1a is a flow diagram of a method for synchronizing two displays according to aspects of some embodiments of the invention.

FIG. 1b is a block diagram illustrating aspects of some embodiments of the invention.

FIG. 2 is an exemplary illustration of some aspects of a preferred embodiment of the invention.

FIG. 3 is a block diagram illustrating a system upon which one or more embodiments of the invention may be implemented.

### DETAILED DESCRIPTION OF PREFERRED EMBODIMENTS OF THE INVENTION

Other and further features and advantages of the present invention will be apparent from the following descriptions of the various embodiments when read in conjunction with the accompanying drawings. It will be understood by one of ordinary skill in the art that the following embodiments are provided for illustrative and exemplary purposes only, and that numerous combinations of the elements of the various embodiments of the present invention are possible.

### Color

Human perception of color is composed of three separate elements: red, green and blue sensors in the eye. Each of these sensors can detect many different levels of intensity. Colors are made up of combinations of the three different elements at different intensities. The human eye can detect over 16 million different colors.

With the growth of eCommerce, an issue has arisen with varying color characteristics of one display, for example a source display associated with a server, and a second display, for example a display associated with a client computing device.

The client display may be on a television, monitor, notebook or tablet computer, smart phone or other device. These devices typically consist of a display driven by a computing device. The computing device usually includes a browser or other program for browsing pages on the Internet and/or other networks.

The source display is the device used, for example, by an eCommerce manager to prepare images of items to be inserted into an Internet Web page. In the case of eCommerce, photography is often used to capture an image of an item to be displayed for sale on a web page. The image is transferred from the capture device to a source display for editing and preparation before it is made available by servers hosting the eCommerce web site.

Both the source and the client displays represent the colors of the images of items based on their color characteristics. These color characteristics include:

1. Red, green and blue color—this is the chromaticity or gamut of the display.

2. White point—this is the color value of the maximum white level.

3. Gamma—this is the non-linear relationship between the increase in a value of the red, green, or blue signal and the increase in the red, green, or blue brightness or luminance.

If any of these color values are represented differently by the source and client display, then the visually perceived colors will be different. The result of a difference in color characteristics will be that the image of the item being viewed by the user on the client display will be different from the colors of the actual object being represented on the Web site.

Items in the world have an absolute color. The absolute color can be measured by instrumentation. The absolute color is device independent, where the absolute color of an object is not changed by how it is displayed on a display device. However, a computer display is device dependent. The color values sent to the display device show a color not in absolute terms, but based on the color capabilities and settings of the device. While the red color of a rose has an absolute color that can be measured, when an image of the rose is captured by a camera and sent to a display device, the representation on the display device is based on the capability of the display device. Different display devices have very different color capabilities.

### Source Color Adjustment

Most source color computer displays at major Web sites are operated by color and/or Web professionals. These operators use calibrated displays. As an example, the calibration may be to the absolute values of the sRGB color standard. The object to be placed on the Web site has its image captured by a camera calibrated to the sRGB color standard and the operators edits and prepares the image on a display calibrated to sRGB.

Web site operators use best practices to provide color accuracy between the colors of the actual item and the colors captured by the capture device. This allows the colors of an image of the item to be displayed correctly on a Web site.

### Client Color Adjustment

Client color computer displays are not calibrated. As an example, relative to an sRGB color standard, the color accuracy of client display can vary greatly. Measured variations can be from 50% to 150% of the colors displayed in an sRGB color standard. Client displays have very limited color adjustment. Users have access to brightness and contrast controls

Users may not prefer the same color setting for all uses of the display. As an example, even if the user had a display with perfect sRGB standard color characteristics they may wish to adjust the colors. As a specific example, some users prefer a bluish color in their white background for text viewing and editing. Some users prefer over-saturated colors for viewing sports programming on the display. Thus, any adjustments made by the user to their preferences will alter the display's color characteristics. Thus, it is important that any user adjustments be reset if the user withes accurate colors for an eCommerce transaction.

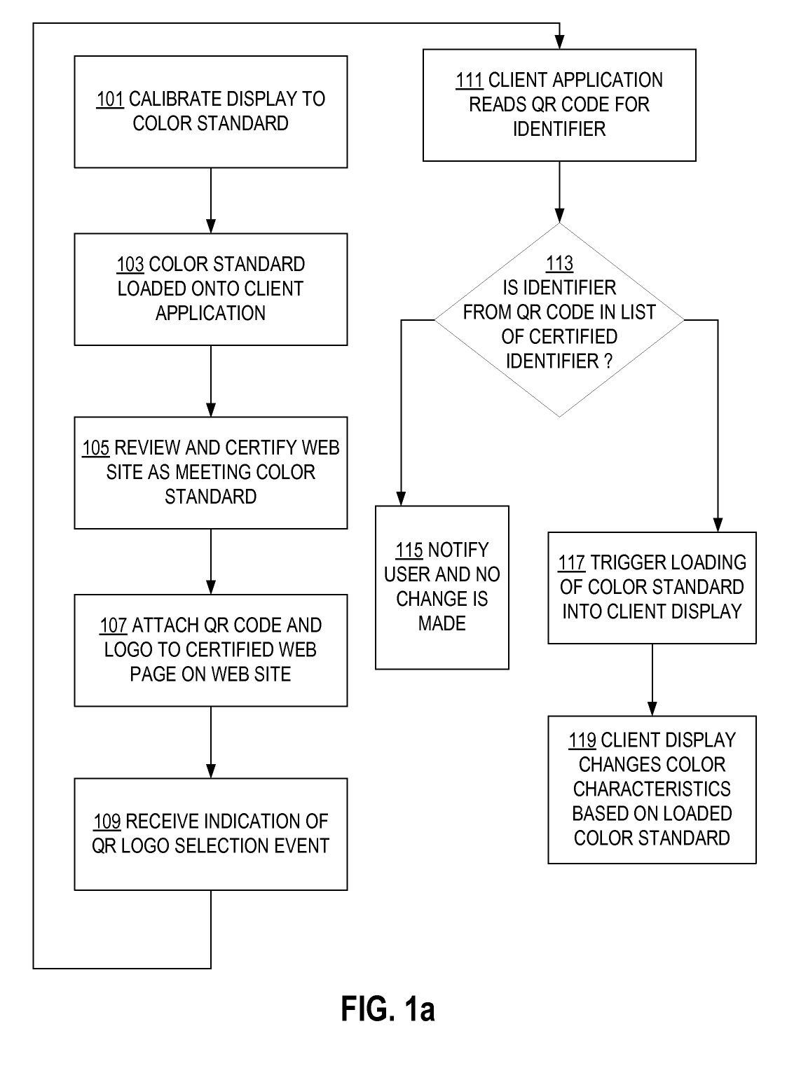

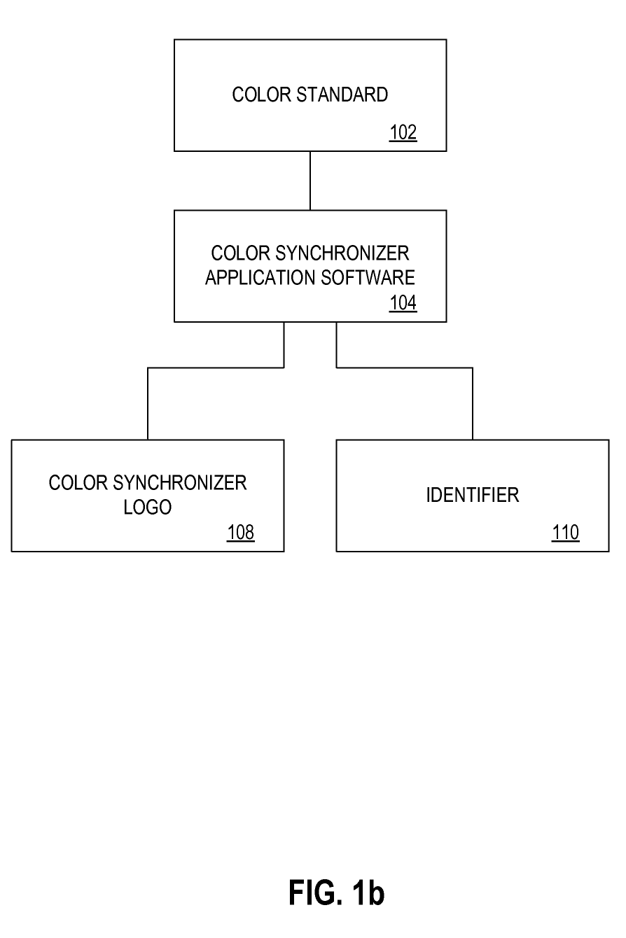

Exemplary methods, apparatus, and systems for color synchronization according to preferred embodiments of the present invention are described with reference to the accompanying figures, beginning with FIGS. 1a and 1b.

FIG. 1a is a flow diagram illustrating process 100 for synchronizing color between a source device and a client device, according to some embodiments of the invention. FIG. 1b is a block diagram illustrating aspects of some embodiments of the invention. Process 100 will allow matching of the color of the item being represented on a client device to the colors of the actual item when the source device and the client device are each calibrated and using the same color standard values.

Initially, it is desirable to calibrate the client device. At step 101, to create a calibrated client display, the display is calibrated to meet a Color Synchronizer color standard 102. The color standard 102 is composed of values for one or more color characteristics, including absolute chromaticity values, absolute gamma values, and a specific white point value. For example, a white point of 6500 kelvin (K) may be used as the specific white point value in the color standard. Additionally, values for color characteristics for a color standard may further comprise, but are not limited to, resolution, contrast, luminance, brightness, hue, saturation, black point, RGB value, chroma, color temperature, primary and secondary colors, color space, CIE value (abbreviated from “Commission internationale de léclairage”, or “International Commission on Illumination”), or color spectra. As part of calibration, compensation values are loaded into the display's color converter so that the results of colors sent to the display meet the calibration specifications for the color standard 102. In one example, the compensation values are determined by measuring the display's output colors with color analyzers or colorimeters, determining the difference between the current output colors and the desired calibrated output colors, and determining compensation values to adjust the output colors to make them the same as the desired colors. In some embodiments, the converter can be turned on and off instantly to invoke the calibrated colors and to override the display's “natural” or default set of color characteristics. After the client display is calibrated, the initial application of the color standard is optional, as the color standard may be later applied by the Color Synchronizer application on the client device. Once the display is calibrated to meet the calibration specifications of the color standard 102, the display may be certified as meeting the Color Synchronizer standard. In some embodiments, after certification, the display is licensed to attach a Color Synchronizer logo, or other logo, image, pattern or symbol, to the device to indicate that it is Color Synchronizer compatible.

At step 103, values corresponding to the Color Synchronizer color standard 102 are loaded into Color Synchronizer application software 104 on the client computing device. In some embodiments, the Color Synchronizer color standard 102 is associated with one of several color modes available on the client. In some embodiments, the Color Synchronizer color standard values are downloaded from a network source when needed. The Color Synchronizer application software 104 can use the color standard values and change the color characteristics of the client display to the calibrated Color Synchronizer color standard 102. The change can be performed as a manual operation by the user by executing the Color Synchronizer application software 104 to apply the color standard values, or the change can be automatically triggered by the Color Synchronizer application software 104.

At step 105, on the source side, a licensed Web site is certified to meet the Color Synchronizer color standard 102. This certification procedure insures that the colors represented on the Web site are the same as the actual colors of the item being displayed.

To be certified, procedures are followed in the preparation of images for the Web site. A display coupled to a server, for example, as well as the camera used to capture an image, are calibrated to meet the Color Synchronizer color standard 102. When the color standard 102 is applied to the server display and the camera, the actual colors of the item are represented. As the same color standard is used to calibrate the camera, the server display, and the client display, the absolute color of the item may be reflected on all devices when the color standard is applied and loaded onto all devices. The sameness of the colors of the actual item and the colors of the item in the images shown on the client and server displays may be measured by using color-analyzing instruments such as a colorimeter.

At step 107, a Color Synchronizer logo 108 is added to Web pages that have been certified as meeting a Color Synchronizer color standard. The logo includes a code or other information that can be used to identify the color standard 102 used by the Web pages, and may also include information that identifies the site. While the examples herein describe using a QR (Quick Response) code, it is understood that other identifying codes, such as 1-D or 2-D barcodes, matrix codes, UPC code, alphanumeric code, embedded data object, or character recognition may be used on the Web site to identify or to encode an identifier for a certified Web site without departing from the spirit of the invention.

At step 109, when a user browses to a Web page that has been licensed to use the Color Synchronizer logo 108, the corresponding Web page with logo 108 is loaded into a browser and rendered on the client display. In some embodiments, the identifier 110 associated with color standard 102 (or other information to be used to identify color standard 102) for use by the Color Synchronizer application 104 is obtained from the server in response to the user action of clicking on the logo 108 or associated code. In some embodiments, the information is sent from the associated server and received by the Color Synchronizer application 104 automatically when the web page is loaded without user input. In other embodiments, the information is requested by the client when the user clicks on the logo 108 and provided by the server after receipt of the request.

At step 111, the Color Synchronizer application 104 on the client reads the identifier 110 and/or associated information. In some embodiments, the Web site operator is identified. In some embodiments, the identifier 110 is directly or indirectly associated with the color standard with which the web page and its images were prepared. In some embodiments, the identifier communicates to the Color Synchronizer the proper color mode for viewing images from the web page.

At step 113, the Color Synchronizer application 104 on the client compares the identifier 110 and/or associated information with stored information to determine if the Web site is certified and the correct Color Synchronizer color standard 102.

At step 115, if the Web site is not certified, the user is notified and no change is made to the client device color characteristics.

At step 117, if the Web site is certified, the client computer is instructed to load the correct Color Synchronizer color standard 102 values into the calibrated client display.

At step 119, the client display's color characteristics change in response to the application of the color standard, if the client display was not previously set with the color standard. After the synchronization, the calibrated client display color characteristics match the color characteristics of the server display at the server side of the transaction. Due to the calibration of the devices against the Color Synchronizer color standard 102, the color characteristics of the server display match the colors of the actual item that was captured by the server operator.

### The Use of QR Codes to Communicate Color Information

QR Codes are a trademark for a new type of barcode. The QR Code system has become popular due to its fast readability and large storage capacity compared to other barcodes. The code consists of square dots arranged in a square pattern on a white background. The use of QR Codes is free of any license. The QR Code is clearly defined and published as an ISO standard.

The process described allows the user of a computer to have confidence that the color represented on their display is the actual color of the item. This is most important in eCommerce where a user investigates or purchases an item from a Web site. As the purchase may be based on the color perceived by the user on the display, the process prevents the many cases where the user receives an item that is different in color from what was displayed on the screen.

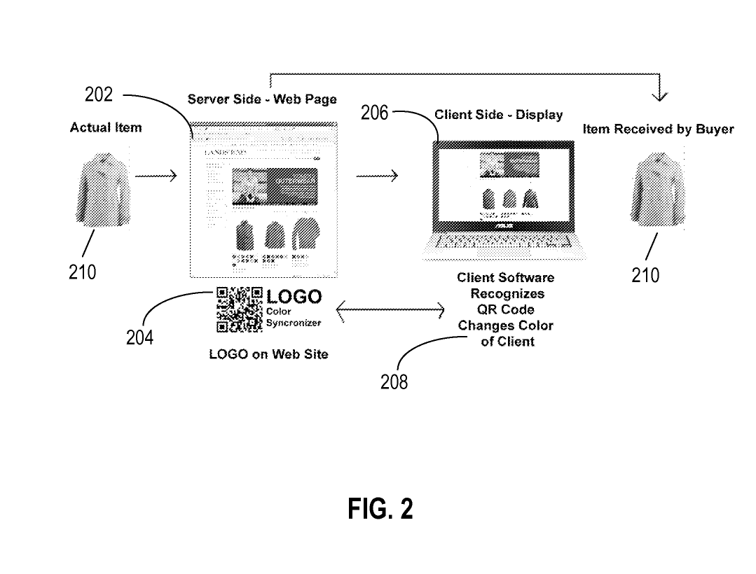

FIG. 2 is an exemplary illustration of some aspects of a preferred embodiment of the invention. FIG. 2 includes representations of certified Web page 202, logo and QR code 204, calibrated client display 206, and client color synchronizer application 208. Certified Web page 202 has one or more digital images created in compliance with a color standard for matching colors in the digital image with the actual colors of the item depicted in the image. As shown in this example, an image of jacket 210 is included on certified Web page 202, which was certified as in compliance with the Color Synchronizer color standard values.

Logo and QR code 204 are displayed on the Web page, which indicates compliance to the user. The QR code includes identifying information for the Web page. The logo may also be any image, pattern or symbol, and the QR code may comprise any identifying code to identify or to encode any identifier for a certified Web site or Web page, without departing from the spirit of the invention. The logo may be selected by a selection event, such as by a click or a touch on the interface. Client application 208 detects the selection event on the logo, and reads the QR code to determine identifier for the Web page. If, based on the identifier, the Web page is a Color Synchronizer certified Web page, client application 208 causes the color standard to be applied to or loaded onto client display 206. The application or loading of the color standard causes the colors of images shown on the display to match the colors intended to be shown by the certified Web page. Because the certified Web page was prepared using the color standard to match the colors in images to the actual colors of the objects, application or loading the color standard on the client causes the client to also display the actual colors of the objects. This is helpful for making the color of the item as shown in an image on a client display the same as the color of the actual object, especially where the item is one that a user is purchasing.

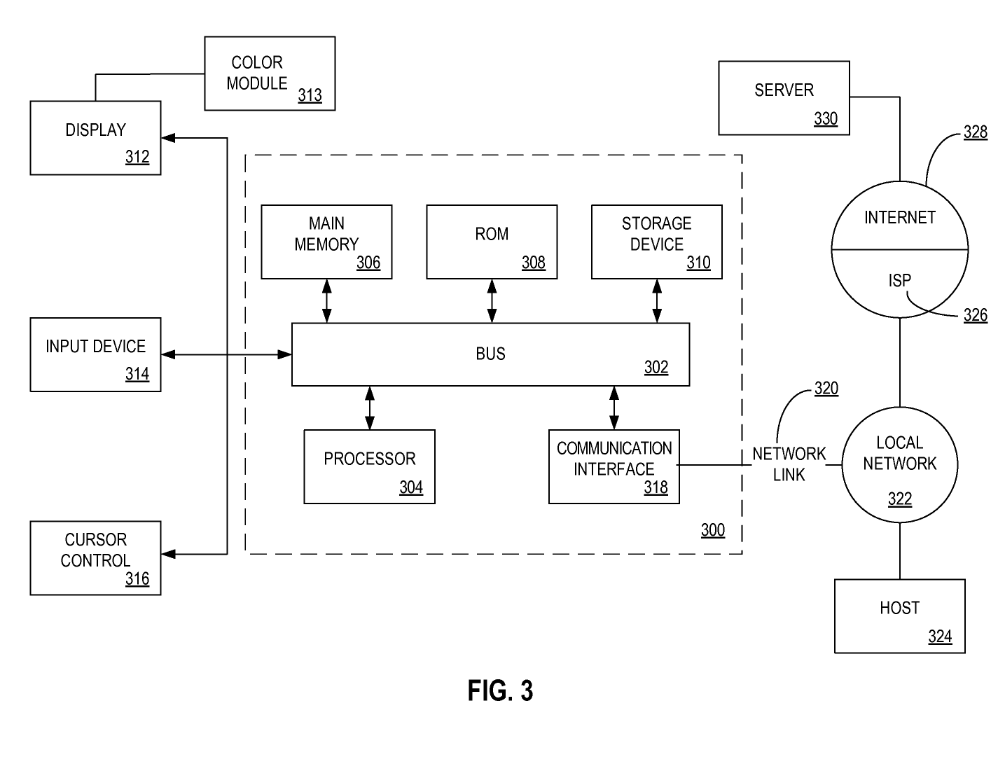

FIG. 3 is a block diagram that illustrates a computer system 300 upon which some embodiments and portions of the invention may be implemented. Computer system 300 includes a bus 302 or other communication mechanism for communicating information, and a processor 304 coupled with bus 302 for processing information. Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Computer system 300 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions.

Computer system 300 may be coupled via bus 302 to a display 312, such as a cathode ray tube (CRT) or liquid crystal display (LCD), for displaying information to a computer user. Display 312 includes color module 313. Color module 313 is for loading one or more color values into the display, and for implementing a color converter into which compensation values are loaded for calibrating a display. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane. In some embodiments, input device 314 is integrated into display 312, such as a touchscreen display for communicating command selections and gestures to processor 304. Another type of input device includes a video camera, a depth camera, or a 3D camera. Another type of input device includes a voice command input device, such as a microphone operatively coupled to speech interpretation module for communication command selection to processor 304.

In some embodiments, computer system 300 may be used for implementing the techniques described herein. According to one embodiment of the invention, those techniques are performed by computer system 300 in response to processor 304 executing one or more sequences of one or more instructions contained in main memory 306. Such instructions may be read into main memory 306 from another machine-readable medium, such as storage device 310. Execution of the sequences of instructions contained in main memory 306 causes processor 304 to perform the process steps described herein. In alternative embodiments, hard-wired circuitry may be used in place of or in combination with software instructions to implement the invention. Thus, embodiments of the invention are not limited to any specific combination of hardware circuitry and software. In further embodiments, multiple computer systems 300 are operatively coupled to implement the embodiments in a distributed system.

The terms “machine-readable medium” as used herein refer to any medium that participates in providing data that causes a machine to operate in a specific fashion. In an embodiment implemented using computer system 300, various machine-readable media are involved, for example, in providing instructions to processor 304 for execution. Such a medium may take many forms, including but not limited to storage media and transmission media. Storage media includes both non-volatile media and volatile media. Non-volatile media includes, for example, optical or magnetic disks, such as storage device 310. Volatile media includes dynamic memory, such as main memory 306. Transmission media includes coaxial cables, copper wire and fiber optics, including the wires that comprise bus 302. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, hard disk, a floppy disk, a flexible disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 304 for execution. For example, the instructions may initially be carried on a magnetic disk of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card or other internet connection device, or a modem to provide a data communication connection to a corresponding type of telephone line. As another example, communication interface 318 may be a local area network (LAN) card to provide a data communication connection to a compatible LAN. Wireless network links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the Internet 328. Local network 322 and Internet 328 both use electrical, electromagnetic or optical signals that carry digital data streams. The signals through the various networks and the signals on network link 320 and through communication interface 318, which carry the digital data to and from computer system 300, are exemplary forms of carrier waves transporting the information.

Computer system 300 can send messages and receive data, including program code, through the network(s), network link 320 and communication interface 318. In the Internet example, a server 310 might transmit a requested code for an application program through Internet 328, ISP 326, local network 322 and communication interface 318.

The received code may be executed by processor 304 as it is received, and/or stored in storage device 310, or other non-volatile storage for later execution. In this manner, computer system 300 may obtain application code in the form of a carrier wave.

Other features, aspects and objects of the invention can be obtained from a review of the figures and the claims. It is to be understood that other embodiments of the invention can be developed and fall within the spirit and scope of the invention and claims.

The foregoing description of preferred embodiments of the present invention has been provided for the purposes of illustration and description. It is not intended to be exhaustive or to limit the invention to the precise forms disclosed. Various additions, deletions and modifications are contemplated as being within its scope. The scope of the invention is, therefore, indicated by the appended claims rather than the foregoing description. Further, all changes which may fall within the meaning and range of equivalency of the claims and elements and features thereof are to be embraced within their scope.

What is claimed is:

1. A method for adjusting color on a calibrated display device, the method comprising the steps of:
receiving a web page that has been prepared according to a first color standard, wherein the web page includes an identifier associated with the first color standard;
extracting the identifier;
determining the identifier's association with the first color standard; and
based on the identifier's association with the first color standard, causing a module of a client display device to apply the color standard values to adjust how colors are displayed on the client display device.

2. The method of claim 1, wherein the color standard comprises chromaticity values, gamma values, and a white point value.

3. The method of claim 1, wherein the web page includes images prepared based on the color standard.

4. The method of claim 1, wherein one or more instructions for performing the extracting, determining, and causing steps is triggered by any one of user input associated with the identifier, or automatically upon the web page's loading.

5. The method of claim 1, wherein the web page is hosted on a server having a server display device, wherein the server display device was previously calibrated to meet the color standard.

6. The method of claim 5, wherein the step of causing a module of a client display to apply the color standard values further causes color synchronization between the client display device and the server display device by causing particular color data to appear as the same colors on the client display device as on the server display device.

7. The method of claim 1, wherein the color standard, as applied to a client display device, causes the client display device to show actual colors of an item shown in an image displayed thereon, wherein the image was taken with a camera previously calibrated to meet the color standard.

8. The method of claim 1, further comprising:
verifying the certification of the web page by comparing the identifier with the identifiers of a set of identifiers correlated with certified web pages; and
the step of causing a module of a client display device to apply the color standard is in response to a verification of the certification of the web page,

9. The method of claim 8, wherein the web page is certified when the images contained therein are prepared based on the color standard.

10. An apparatus for adjusting color on a calibrated display device, the apparatus comprising:
a web page that has been prepared according to a first color standard;
an identifier included in the web page, the identifier associated with the first color standard, the identifier triggering executing instructions to perform the steps of:
extracting the identifier;
determining the identifier's association with the first color standard; and
based on the identifier's association with the first color standard, causing a module of a client display device to apply the color standard values to adjust how colors are displayed on the client display device.

11. A computer-readable medium carrying one or more sequences of instructions, which when executed by said one or more processors, implement a method for adjusting color on a display device, the method comprising the steps of:
receiving a web page that has been prepared according to a first color standard, wherein the web page includes an identifier associated with the first color standard;
extracting the identifier;
determining the identifier's association with the first color standard; and
based on the identifier's association with the first color standard, causing a module of a client display device to apply the color standard values to adjust how colors are displayed on the client display device.

12. The computer-readable medium of claim 11, wherein the color standard comprises chromaticity values, gamma values, and a white point value.

13. The computer-readable medium of claim 11, wherein the web page includes images prepared based on the color standard.

14. The computer-readable medium of claim 11, wherein one or more instructions for performing the extracting, determining, and causing steps is triggered by any one of user input associated with the identifier, or automatically upon the web page's loading.

15. The computer-readable medium of claim 11, wherein the web page is hosted on a server having a server display device, wherein the server display device was previously calibrated to meet the color standard.

16. The computer-readable medium of claim 15, wherein the step of causing a module of a client display to apply the color standard further causes color synchronization between the client display device and the server display device by causing particular color data to appear as the same colors on the client display device as on the server display device.

17. The computer-readable medium of claim 11, wherein the color standard, as applied to a client display device, causes the client display device to show actual colors of an item shown in an image displayed thereon, wherein the image was taken with a camera previously calibrated to meet the color standard.

18. The computer-readable medium of claim 11, the method further comprising:
verifying the certification of the first web page by comparing the identifier from the identifying code and the identifiers of a set of identifiers correlated with certified web pages; and
the step of causing a module of a client display device to apply the color standard is in response a verification of the certification of the first web page,

19. The computer-readable medium of claim 18, wherein the web page is certified when the images contained therein are prepared based on the color standard.
